(19) United States
(12) Patent Application Publication
(10) Pub. No.: US 2013/0121160 A1
(43) Pub. Date: May 16, 2013

(54) METHOD OF AVOIDING INTERFERENCE IN A MULTI-PICONET

(71) Applicants: Jin-Yong CHUNG, Seoul (KR); Hyuk-Chin CHANG, Seoul (KR); Chang-Won NAM, Seoul (KR)

(72) Inventors: Jin-Yong CHUNG, Seoul (KR); Hyuk-Chin CHANG, Seoul (KR); Chang-Won NAM, Seoul (KR)

(21) Appl. No.: 13/469,495

(22) Filed: May 11, 2012

(30) Foreign Application Priority Data
Nov. 11, 2011 (KR) 10-2011 -0117333

(51) Int. Cl. H04B 15/00; H04W 28/26; H04W 24/02

(52) U.S. Cl. 370/241; 370/330

(57) ABSTRACT

A wireless device in a first piconet using a first time-frequency code senses interference from a second piconet using a second time-frequency code that is different from the first time-frequency code. The wireless device detects a beacon period of the second piconet. The wireless device reserves at least one medium access slot corresponding to the beacon period of the second piconet among a plurality of medium access slots of the first piconet.

### CROSS-REFERENCE TO RELATED APPLICATIONS

This U.S. non-provisional application claims the benefit of priority under 35 U.S.C. §119 to Korean Patent Application No. 10-2011-0117333 filed on Nov. 11, 2011 in the Korean Intellectual Property Office (KIPO), the entire content of which is incorporated herein by reference in its entirety.

### TECHNICAL FIELD

The present invention relates to wireless communication. More particularly, the present invention relates to methods of avoiding interference in multi-piconets.

### DISCUSSION OF THE RELATED ART

Ultra-wideband (UWB) communication is a radio technology in which signals are wirelessly transmitted and received at relatively low energy levels. UWB may be used for short-range high-bandwidth communications using a large portion of radio spectrum. UWB communication may be generally classified as either direct sequence code division multiple access (DS-CDMA) UWB communication or multi-band orthogonal frequency division multiplexing (MB-OFDM) UWB communication. DS-CDMA UWB communication allows for multiple accesses by spreading signals with different codes. MB-OFDM UWB communication performs frequency hopping among frequency bands, of which each band has a bandwidth of about 528 MHz, to achieve multiple accesses and frequency diversity. MB-OFDM UWB communication may provide adequate diversity and may reduce multi-piconet interference by performing frequency hopping per symbol.

### SUMMARY

Exemplary embodiments of the present invention provide a method of avoiding interference in a multi-piconet.

According to exemplary embodiments, in a method of avoiding interference in a multi-piconet, a wireless device in a first piconet using a first time-frequency code senses interference from a second piconet using a second time-frequency code that is different from the first time-frequency code. The wireless device detects a beacon period of the second piconet. The wireless device reserves at least one medium access slot corresponding to the beacon period of the second piconet among a plurality of medium access slots of the first piconet.

According to exemplary embodiments, to sense the interference from the second piconet, the wireless device may receive a packet and may determine whether a preamble included in the received packet corresponds to the first time-frequency code.

According to exemplary embodiments, to sense the interference from the second piconet, the wireless device may receive a packet and may determine whether the interference from the second piconet exists based on a receiver signal strength indicator (RSSI) and a link quality indicator (LQI) of a symbol included in the received packet.

According to exemplary embodiments, to detect the beacon period of the second piconet, the wireless device may receive a beacon of the second piconet by overhearing a packet transmitted from the second piconet by using the second time-frequency code and may detect the beacon period of the second piconet based on a beacon period occupancy information element included in the received beacon of the second piconet.

According to exemplary embodiments, to reserve the at least one medium access slot corresponding to the beacon period of the second piconet, the at least one medium access slot that overlaps in time with the beacon period of the second piconet may be reserved as an interference piconet beacon period protection type.

According to exemplary embodiments, to reserve the at least one medium access slot corresponding to the beacon period of the second piconet, a predetermined value indicating an interference piconet beacon period protection type may be written into a reservation type field of a distributed reservation protocol information element. The wireless device may broadcast a beacon including the distributed reservation protocol information element in the first piconet.

According to exemplary embodiments, the predetermined value indicating the interference piconet beacon period protection type may be one of 5, 6, or 7.

According to exemplary embodiments, if the at least one medium access slot is reserved, a wireless device in the first piconet may refrain from transmitting a packet during the reserved one medium access slot.

According to exemplary embodiments, in a method of avoiding interference in a multi-piconet including a first piconet using a first time-frequency code and a second piconet using a second time-frequency code that is different from the first time-frequency code, a first wireless device in the first piconet classifies a plurality of medium access slots of the first piconet into occupied medium access slots that are reserved by at least one second wireless device in the first piconet, interference medium access slots where interference from the second piconet exists, and free medium access slots that are not reserved and are not affected by the interference from the second piconet. If a number of medium access slots to be used to transmit a packet by the first wireless device is less than or equal to a number of the free medium access slots, the first wireless device reserves at least one of the free medium access slots to transmit the packet. If the number of the medium access slots to be used to transmit the packet by the first wireless device is greater than the number of the free medium access slots, the first wireless device requests the second wireless device to swap at least one of the occupied medium access slots and at least one of the interference medium access slots.

According to exemplary embodiments, to classify the plurality of medium access slots into the occupied medium access slots, the interference medium access slots and the free medium access slots, a beacon from the second wireless device may be received during a beacon period of the first piconet by using the first time-frequency code and the occupied medium access slots may be determined based on a distributed reservation protocol information element included in the received beacon.

According to exemplary embodiments, to classify the plurality of medium access slots into the occupied medium access slots, the interference medium access slots and the free medium access slots, a beacon may be received from an interference wireless device in the second piconet during a beacon period of the second piconet by using the second time-frequency code. Medium access slots of the second piconet reserved by the interference wireless device may be checked based on a distributed reservation protocol information element included in the received beacon. The interference medium access slots of the first piconet that overlaps in time with the medium access slots of the second piconet reserved by the interference wireless device may be determined.

According to exemplary embodiments, to determine the interference medium access slots of the first piconet, numbers of the medium access slots of the second piconet reserved by the interference wireless device may be converted into numbers corresponding to the first piconet based on a time difference between a beacon period start time of the first piconet and a beacon period start time of the second piconet.

According to exemplary embodiments, to classify the plurality of medium access slots into the occupied medium access slots, the interference medium access slots and the free medium access slots, medium access slots among the plurality of medium access slots of the first piconet that are neither the occupied medium access slots nor the interference medium access slots may be determined as the free medium access slots.

According to exemplary embodiments, to request the second wireless device to swap at least one of the occupied medium access slots and at least one of the interference medium access slots, the first wireless device may generate a medium access slot swap information element including information about the at least one of the occupied medium access slots reserved by the second wireless device and information about the at least one of the interference medium access slots where the interference from the second piconet exists. The medium access slot swap information element may be transmitted to the second wireless device.

According to exemplary embodiments, to generate the medium access slot swap information element, an address of the second wireless device may be written into an address field of the medium access slot swap information element. The information about the at least one of the occupied medium access slots may be written into a first medium access slot information field of the medium access slot swap information element. The information about the at least one of the interference medium access slots may be written into a second medium access slot information field of the medium access slot swap information element.

According to exemplary embodiments, a method for controlling a piconet, includes detecting, by a first wireless device in a first piconet that uses a first time-frequency code, a second piconet using a second time-frequency code that is different from the first time-frequency code. A beacon period of the second piconet is identifies, by the first wireless device in the first piconet. The first piconet refrains from transmitting packets during a medium access slot (MAS) that overlaps in time with the identified beacon period of the second piconet.

The first piconet may refrain from transmitting packets during the MAS that overlaps in time with the identified beacon period of the second piconet by reserving the MAS that overlaps in time with the identified beacon period of the second piconet as a reserved MAS.

Detecting the second piconet may include receiving a packet at the first wireless device of the first piconet, determining whether a preamble of the received packet corresponds to the first time-frequency code, and detecting the second piconet when the preamble of the received packet is determined to not correspond to the first time-frequency code.

The method may also include determining, by the first wireless device in the first piconet, whether there is a sufficient number of MASs that do no overlap in time with the identified beacon period of the second piconet. When it is determined that there is not a sufficient number of MASs that do no overlap in time with the identified beacon period of the second piconet, the first wireless device in the first piconet may send a request to a second wireless device in the first piconet to swap a MAS that is used for transmitting packets for a MAS that overlaps in time with the identified beacon period of the second piconet.

The first wireless device in the first piconet may transmit packets during one or more MASs that do not overlap in time with the identified beacon period of the second piconet.

### BRIEF DESCRIPTION OF THE DRAWINGS

Illustrative, non-limiting exemplary embodiments of the present invention are described below in conjunction with the accompanying drawings, wherein:

FIG. 1 is a diagram illustrating a multi-piconet where interference occurs between two piconets;

FIG. 2 is a diagram illustrating a multi-piconet where interference occurs due to symbol collision between two piconets using different time-frequency codes;

FIG. 3 is a flow chart illustrating a method of avoiding interference in a multi-piconet according to exemplary embodiments of the present invention;

FIG. 4 is a diagram illustrating a step of reserving a medium access slot corresponding to a beacon period of an interference piconet in an interference avoidance method of FIG. 3;

FIG. 5 is a diagram illustrating values written into a reservation type field of a distributed reservation protocol information element (DRPIE) according to exemplary embodiments of the present invention;

FIG. 6 is a flow chart illustrating a method of avoiding interference in a multi-piconet according to exemplary embodiments of the present invention;

FIG. 7 is a flow chart illustrating a step of classifying a medium access slot in an interference avoidance method of FIG. 6;

FIGS. 8A and 8B are diagrams illustrating converting numbers of medium access slots of a second piconet into numbers of medium access slots of a first piconet in an interference avoidance method of FIG. 6;

FIG. 9 is a diagram illustrating an example of swapping occupied medium access slots and interference medium access slots in an interference avoidance method of FIG. 6;

FIG. 10 is a diagram illustrating an example of a MAS swap IE that may be used in an interference avoidance method of FIG. 6;

FIG. 11 is a diagram illustrating an example of a MAS swap IE that may be used in an interference avoidance method of FIG. 6;

FIG. 12 is a flow chart illustrating a method of avoiding interference in a multi-piconet according to exemplary embodiments of the present invention; and

FIG. 13 is a block diagram illustrating a wireless device according to exemplary embodiments of the present invention.

### DETAILED DESCRIPTION

Various exemplary embodiments will be described more fully hereinafter with reference to the accompanying drawings. The present inventive concept may, however, be embodied in many different forms and should not be construed as limited to the exemplary embodiments set forth herein. In the drawings, the sizes and relative sizes of layers and regions may be exaggerated for clarity.

it will be understood that when an element or layer is referred to as being “on,” “connected to,” or “coupled to” another element or layer, it can be directly on, connected or coupled to the other element or layer or intervening elements or layers may be present. Like numerals may refer to like elements throughout.

It will be understood that, although the terms first, second, third etc. may be used herein to describe various elements, components, regions, layers and/or sections, these elements, components, regions, layers and/or sections should not be limited by these terms.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein may be interpreted accordingly.

Exemplary embodiments may be described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place.

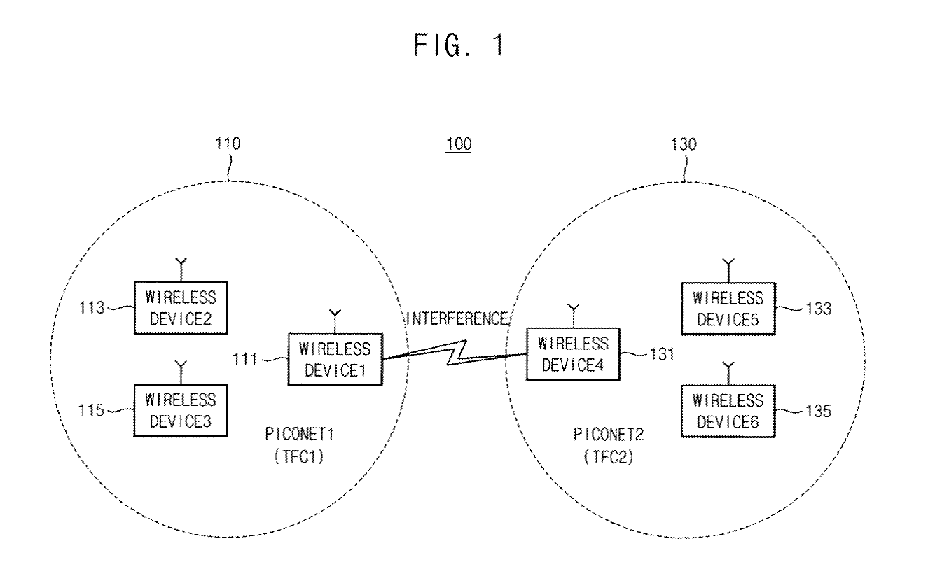

FIG. 1 is a diagram illustrating an example of a multi-piconet where interference occurs between two piconets.

Referring to FIG. 1, a multi-piconet 100 may include adjacent first and second piconets 110 and 130. The first piconet 110 may include a first wireless device 111, a second wireless device 113 and a third wireless device 115. The second piconet 130 may include a fourth wireless device 131, a fifth wireless device 133 and a sixth wireless device 135.

If the first and second piconets 110 and 130 using different time-frequency codes are located adjacent to each other, interference may occur between the adjacent first and second piconets 110 and 130. For example, when a wireless device moves or when an additional wireless device is newly powered on, a region of the first piconet 110 using a first time-frequency code TFC1 may overlap at least a portion of a region of the second piconet 130 using a second time-frequency code TFC2, or the first and second piconets 110 and 130 using the different time-frequency codes TFC1 and TFC2 may be located adjacent to each other. In this case, interference from the second piconet 130 may occur in the first piconet 110, and interference from the first piconet 110 may occur in the second piconet 130. Here, the second piconet 130 adjacent to the first piconet 110 may be referred to as an “interference piconet” of the first piconet 110, and the first piconet 110 adjacent to the second piconet 130 may be referred to as an “interference piconet” of the second piconet 130.

For example, the first wireless device 111 in the first piconet 110 may be affected by interference from the fourth wireless device 131 in the second piconet 130, and a signal-to-noise ratio (SNR) of a desired signal received from the second wireless device 113 or the third wireless device 115 in the first piconet 110 may be reduced due to an undesired signal transmitted from the fourth wireless device 131 in the second piconet 130. Further, the fourth wireless device 131 in the second piconet 130 may be affected by interference from the first wireless device 111 in the first piconet 110, and an SNR of a desired signal received from the fifth wireless device 133 or the sixth wireless device 135 in the second piconet 130 may be reduced due to an undesired signal transmitted from the first wireless device 111 in the first piconet 110. Thus, interference may occur between adjacent wireless devices 111 and 131 belonging to different piconets 110 and 130. Here, the fourth wireless device 131 adjacent to the first wireless device 111 may be referred to as an “interference wireless device” of the first wireless device 111, and the first wireless device 111 adjacent to the fourth wireless device 131 may be referred to as an “interference wireless device” of the fourth wireless device 131.

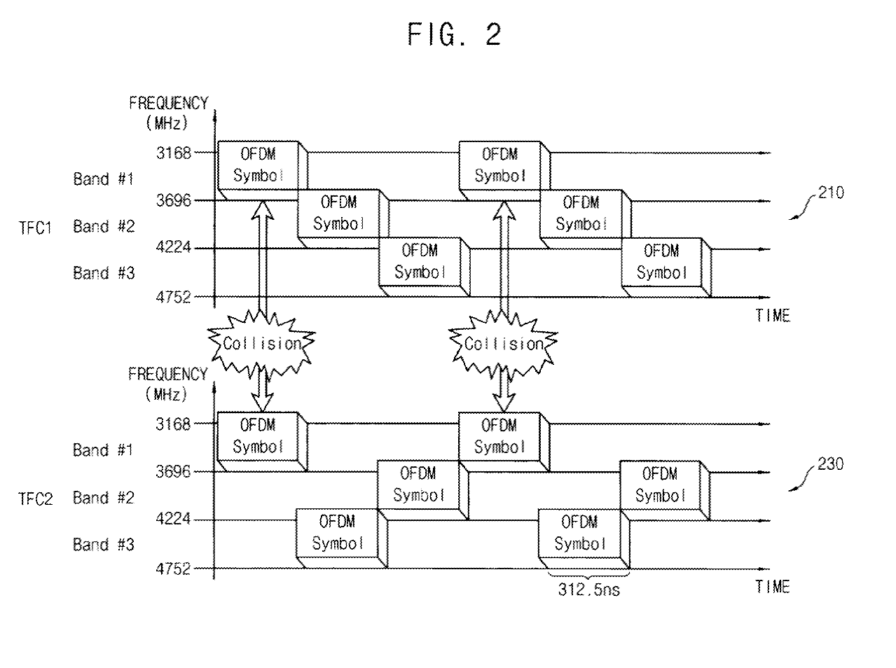

In a case where adjacent piconets use the same time-frequency code, beacon periods of the adjacent piconets may be merged and accordingly, the adjacent piconets may be merged. Interference between the adjacent piconets may thereby be removed. In a case where the adjacent piconets 110 and 130 use the different time-frequency codes TFC1 and TFC2, the adjacent piconets 110 and 130 may not be merged since the adjacent piconets 110 and 130 have different frequency hopping sequences. In this case, as illustrated in FIG. 2, the different time-frequency codes TFC1 and TFC2 used by the adjacent piconets 110 and 130 may partially overlap each other, and interference may occur due to symbol collision between the adjacent piconets 110 and 130. A method of avoiding interference in the multi-piconet 100 according to exemplary embodiments of the present invention may avoid such interference between the adjacent piconets 110 and 130 using different time-frequency codes TFC1 and TFC2.

FIG. 2 is a diagram illustrating an example of adjacent piconets in which interference occurs due to symbol collision between two piconets using different time-frequency codes.

Referring to FIGS. 1 and 2, a first piconet 110 may use a first time-frequency code TFC1. A second piconet 130 may use a second time-frequency code TFC2. For example, the first time-frequency code TFC1 may have a value of “123123,” and wireless devices 111, 113, and 115 of the first piconet 110 may perform frequency hopping 210 in order of a first band, a second band, a third band, the first band, the second band, and the third band. The second time-frequency code TFC2 may have a value of “132132,” and wireless devices 131, 133, and 135 of the second piconet 130 may perform frequency hopping 230 in order of the first band, the third band, the second band, the first band, the third band, and the second band.

As illustrated in FIG. 2, since first symbols (e.g., orthogonal frequency division multiplexing (OFDM) symbols) and fourth symbols of the first and second piconets 110 and 130 are transmitted in the same frequency band (e.g. the first band) symbol collision may occur between the first and second piconets 110 and 130 and interference may occur between the first and second piconets 110 and 130. A method of avoiding interference in a multi-piconet 100 according to exemplary embodiments may avoid such interference between the first and second piconets 110 and 130 using the different time-frequency codes TFC1 and TFC2.

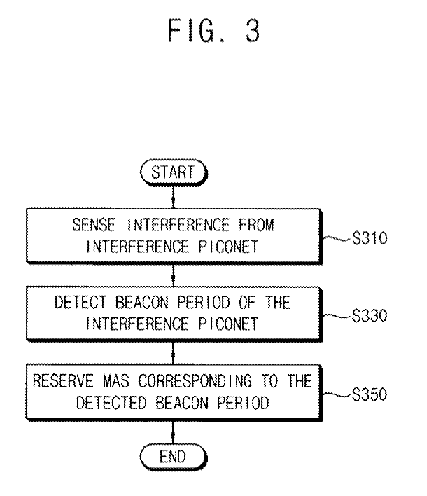

FIG. 3 is a flow chart illustrating a method of avoiding interference in a multi-piconet according to exemplary embodiments of the present invention.

Referring to FIGS. 1 and 3, a first wireless device 111 in a first piconet 110 using a first time-frequency code TFC1 may sense interference from a second piconet 130 using a second time-frequency code TFC2 that is different from the first time-frequency code TFC1 (S310). The first wireless device 111 may sense the interference from the second piconet 130 by analyzing a preamble and/or a symbol included in a received packet.

In some exemplary embodiments of the present invention, to sense the interference from the second piconet 130, the first wireless device 111 may determine whether the preamble included in the received packet corresponds to the first time-frequency code TFC1. For example, the first wireless device 111 may determine whether the preamble may have a synchronization sequence corresponding to the first time-frequency code TFC1. The synchronization sequence may be comprised of twenty-four or twelve symbols at the beginning of the received packet, and may vary depending on each time-frequency code. Thus, the first wireless device 111 may determine whether the synchronization sequence of the preamble included in the received packet is a synchronization sequence corresponding to the first time-frequency code TFC1 to determine whether the packet is received from its own piconet (e.g., the first piconet 110) or from an interference piconet (e.g., the second piconet 130). In some exemplary embodiments, the first wireless device 111 may measure cross-correlation between the synchronization sequence of the preamble included in the received packet and the synchronization sequence corresponding to the first time-frequency code TFC1, and may decide that the interference from the second piconet 130 exists if the measured cross-correlation is low.

In some exemplary embodiments, however, to sense the interference from the second piconet 130, the first wireless device 111 may check a signal-to-interference-plus-noise ratio (SINR) of at least one symbol included in the received packet. For example, the first wireless device 111 may determine whether the interference from the second piconet 130 exists based on a receiver signal strength indicator (RSSI) and a link quality indicator (LQI) of the symbol included in the received packet. The RSSI may represent an energy level of a signal measured at a receiving antenna, and may have a value, for example, ranging from about 0 to about 255. The LQI may represent an SINR of a converted signal on which a fast Fourier transform (FFT) operation is performed, and may have a value, for example, ranging from about −6 dB to about −24 dB. In a case where the interference from the second piconet 130 does not exist, six consecutive symbols included in the received packet may have similar RSSIs and similar LQIS. However, in a case where the interference from the second piconet 130 exists, at least one of the consecutive symbols may have a relatively high RSSI and a relatively low LQI. Accordingly, the first wireless device 111 may decide that interference from the second piconet 130 exists if at least one symbol has a high RSSI and a low LQI.

According to exemplary embodiments, to sense the interference from the second piconet 130, the first wireless device 111 may check both of the synchronization sequence of the preamble and the SINR of the symbol.

If the interference from the second piconet 130 is sensed, the first wireless device 111 may detect a beacon period of the second piconet 130 (S330). After the interference from the second piconet 130 is sensed, the first wireless device 111 may receive a beacon of the second piconet 130. For example, to receive the beacon of the second piconet 130, the first wireless device 111 may overhear a packet transmitted/received in the second piconet 130 by using the second time-frequency code TFC2 during a period in which the interference from the second piconet 130 is sensed. If the beacon of the second piconet 130 is received, the first wireless device 111 may detect a beacon period start time (BPST) of the second piconet 130 based on a time point at which the beacon of the second piconet 130 starts to be received, and may detect a beacon period length of the second piconet 130 based on a beacon period occupancy information element (BPOIE) included in the beacon of the second piconet 139. Thus, the first wireless device 111 may detect the start time and the length of the beacon period of the second piconet 130 by receiving the beacon of the second piconet 130 by using the second time-frequency code TFC2.

If the beacon period of the second piconet 130 is detected, the first wireless device 111 may reserve at least one medium access slot (MAS) corresponding to the beacon period of the second piconet 130 among a plurality of medium access slots within a superframe of the first piconet 110 (S350). The first wireless device 111 may reserve the at least one medium access slot that overlaps in time with the beacon period of the second piconet 130 as an interference piconet beacon period protection type. For example, to reserve the at least one medium access slot as the interference piconet beacon period protection type, the first wireless device 111 may write a predetermined value indicating the interference piconet beacon period protection type into a reservation type field of a distributed reservation protocol information element (DRPIE), and may broadcast a beacon including the DRPIE in the first piconet 110. In some exemplary embodiments, the predetermined value indicating the interference piconet beacon period protection type may be one of 5, 6, or 7.

If the at least one medium access slot corresponding to the beacon period of the second piconet 130 is reserved, wireless devices 111, 113, and 115 in the first piconet 110 may refrain from transmitting a packet during the reserved at least one medium access slot. Accordingly, during the beacon period of the second piconet 130, the second piconet 130 may not be affected by an interference from the first piconet 110, and a fourth wireless device 131 in the second piconet 130 may receive beacons from a fifth wireless device 133 and a sixth wireless device 135 without the interference from the first piconet 110.

As described above, the first wireless device III may sense the interference from the second piconet 130, and may protect the beacon period of the second piconet 130 by reserving the at least one medium access slot corresponding to the beacon period of the second piconet 130. Similarly, the fourth wireless device 131 in the second piconet 130 may sense interference from the first piconet 110 and may protect a beacon period of the first piconet 110 by reserving at least one medium access slot of the second piconet 130 corresponding to the beacon period of the first piconet 110. In a multi-piconet, if interference occurs during a beacon period, a beacon may not be received in a piconet, and thus the piconet may not be maintained. However, a method of avoiding interference in a multi-piconet 100 according to exemplary embodiments may reserve at least one medium access slot corresponding to a beacon period of an adjacent piconet not to transmit a packet during the beacon period of the adjacent piconet and thus the adjacent piconet may not be affected by the interference during its beacon period. Accordingly, in the adjacent piconet, a beacon may be correctly transmitted and received without the interference.

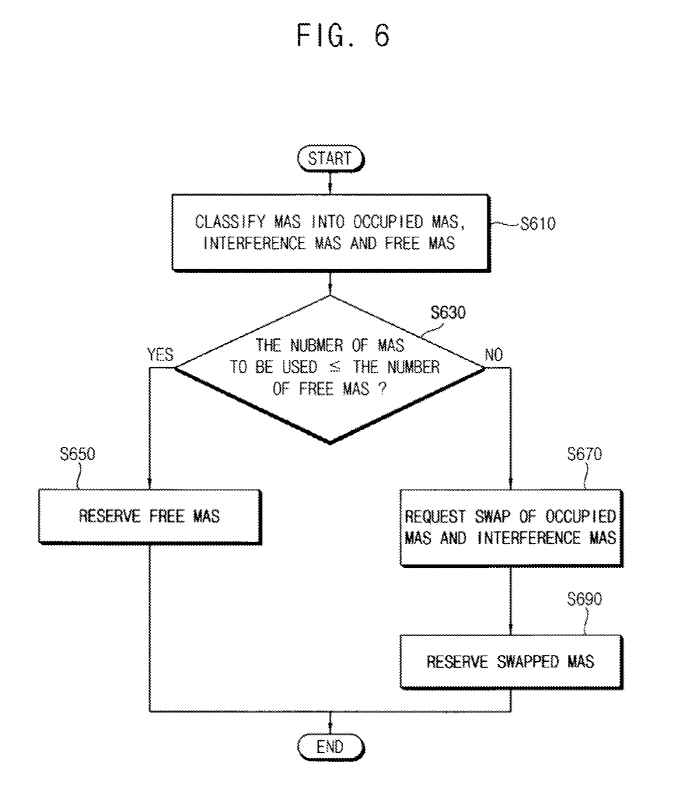

If interference occurs during a data period, an error may occur at a packet, such as a control frame, a command frame, a data frame, etc. In some exemplary embodiments, wireless devices 111, 113, 115, 131, 133, and 135 may retransmit the packet where the error occurs. In some exemplary embodiments, as illustrated in FIG. 6, a wireless device (e.g., the first wireless device 111 and/or the fourth wireless device 131) adjacent to an interference piconet may use a medium access slot where interference from the interference piconet does not exist to avoid the interference from the interference piconet. In some exemplary embodiments, the wireless device (e.g., the first wireless device 111 and/or the fourth wireless device 131) adjacent to the interference piconet may reserve at least one medium access slot where the interference from the interference piconet exists so as not to transmit the packet during the at least one medium access slot.

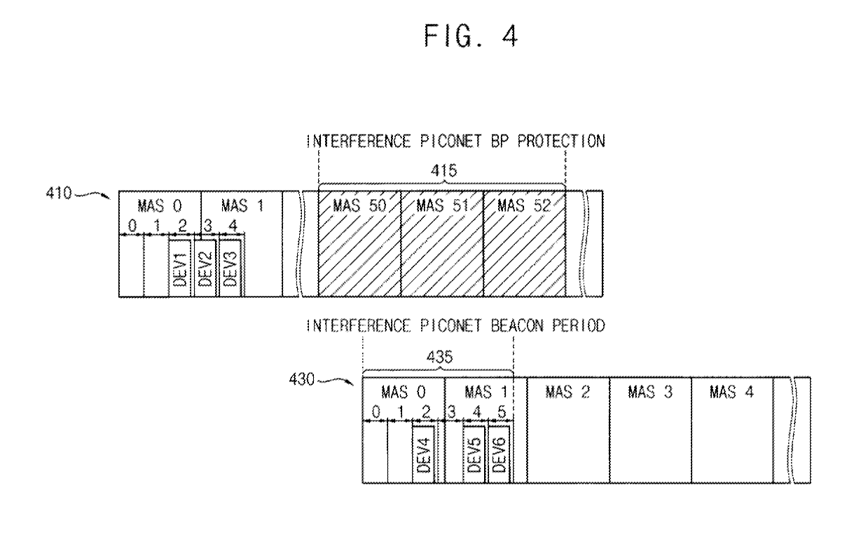

FIG. 4 is a diagram illustrating a step of reserving a medium access slot corresponding to a beacon period of an interference piconet in an interference avoidance method of FIG. 3.

Referring to FIGS. 1 and 4, if a first wireless device 111 in a first piconet 110 using a first time-frequency code TFC1 senses interference from a second piconet 130 using a second time-frequency code TFC2, the first wireless device 111 may detect a beacon period 435 of the second piconet 130. The first wireless device 111 may reserve at least one medium access slot 415 of the first piconet 110 corresponding to the beacon period 435 of the second piconet 130 as an interference piconet beacon period protection type.

For example, first and second medium access slots MAS0 and MAS1 included in a superframe 430 of the second piconet 130 may be used to transmit a beacon in the second piconet 130. The first wireless device 111 may overhear the beacon of the second piconet 130 by using the second time-frequency code TFC2 during the first and second medium access slots MAS0 and MAS1 of the second piconet 130. The first wireless device 111 may detect the beacon period 435 of the second piconet 130 based on information included in the beacon of the second piconet 130. The beacon period 435 of the second piconet 130 may overlap in time with fifty-first, fifty-second, and fifty-third medium access slots MAS50, MAS51, and MAS52 included in a superframe 410 of the first piconet 110. In this case, the first wireless device 111 may reserve the fifty-first, fifty-second, and fifty-third medium access slots MAS50, MAS51, and MAS52 included in the superframe 410 as the interference piconet beacon period protection type. Accordingly, wireless devices 131, 133, and 135 in the second piconet 130 may transmit and receive the beacon without interference from wireless devices 111, 113, and 115 in the first piconet 110 during the beacon period 435.

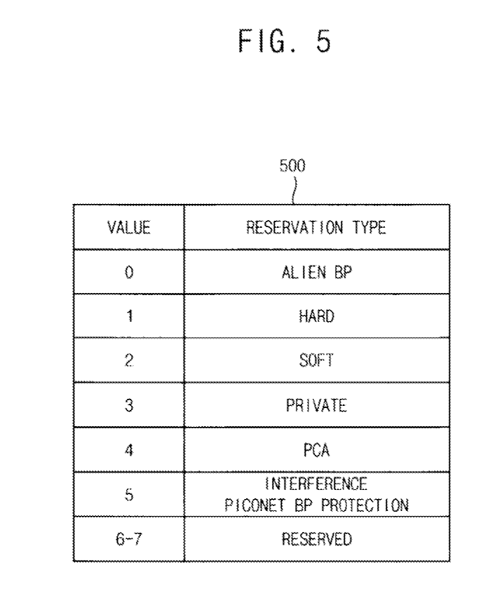

FIG. 5 is a diagram illustrating an example of values written into a reservation type field of a distributed reservation protocol information element (DRPIE) according to exemplary embodiments of the present invention.

As illustrated in a table 500 about reservation types, a reservation type field of a distributed reservation protocol information element (DRPIE) may have a value of one of 0, 1, 2, 3, 4, or 5.

For example, a value “0” of the reservation type field may indicate an alien beacon period (BP) reservation type, and a DRPIE with the alien BP reservation type may be used to prevent transmission during a medium access slot occupied by an alien beacon period. Here, the alien beacon period is a beacon period of an alien piconet using a time-frequency code that is the same as a time-frequency code of a current piconet. The alien beacon period is also different from a beacon period of an interference piconet using a time-frequency code different from the time-frequency code of the current piconet. A value “1” of the reservation type field may indicate a hard reservation type. A DRPIE with the hard reservation type may be used to provide exclusive access to a medium access slot for a reservation owner and a reservation target. A value “2” of the reservation type field may indicate a soft reservation type. A DRPIE with the soft reservation type may be used to permit a prioritized contention access (PCA) and to allow a reservation owner to have a preferential access. A value “3” of the reservation type field may indicate a private reservation type. A DRPIE with the private reservation type may be used to provide exclusive access to a medium access slot for a reservation owner and a reservation target. A medium access slot reserved as the private reservation type may be accessed in accordance with various channel access methods. A value “4” of the reservation type field may indicate a PCA reservation type. A DRPIE with the PCA reservation type may be used to permit the PCA. Values “6” and “7” of the reservation type field may be reserved for a future use.

A value “5” of the reservation type field may indicate an interference piconet BP protection type. A DRPIE with the interference piconet BP protection type may be used to reserve a medium access slot corresponding to the beacon period of the interference piconet not to transmit a packet by any wireless device in the current piconet during the beacon period of the interference piconet. For example, referring to FIG. 1, a first wireless device 111 may reserve a medium access slot of a first piconet 110 corresponding to a beacon period of a second piconet 130 using the DRPIE with the interference piconet BP protection type. Accordingly, during the reserved medium access slot of the first piconet 110, or during the beacon period of the second piconet 130, the second piconet 130 may not be affected by interference from the first piconet 110. Further, a fourth wireless device 131 may reserve a medium access slot of the second piconet 130 corresponding to a beacon period of the first piconet 110 using the DRPIE with the interference piconet BP protection type. Accordingly, during the reserved medium access slot of the second piconet 130, or during the beacon period of the first piconet 110, the first piconet 110 may not be affected by interference from the second piconet 130.

Although FIG. 5 illustrates an example where the value indicating the interference piconet BP protection type is 5, according to exemplary embodiments, the value indicating the interference piconet BP protection type may be 6 or 7. As described above, the beacon period of the interference piconet may be protected by reserving at least one corresponding medium access slot using the DRPIE. According to exemplary embodiments, a new information element that is not defined in the current standard may be used to reserve the at least one corresponding medium access slot.

FIG. 6 is a flow chart illustrating a method of avoiding interference in a multi-piconet according to exemplary embodiments.

Referring to FIGS. 1 and 6, a first wireless device 111 in a first piconet 110 may classify a plurality of medium access slots of the first piconet 110 into occupied medium access slots, interference medium access slots, and free medium access slots (S610). Here, the occupied medium access slots are medium access slots reserved by another wireless device (e.g., a second wireless device 113 and/or a third wireless device 115) in a current piconet. The interference medium access slots are medium access slots where interference from an interference piconet (e.g., a second piconet 130) using a time-frequency code (e.g., TFC2) different from a time-frequency code (e.g., TFC1) of the current piconet is present. The free medium access slots are medium access slots that are not reserved by the other wireless device in the current piconet and are not substantially affected by the interference from the interference piconet.

For example, the first wireless device 111 may receive a beacon from the second wireless device 113 and the third wireless device 115 during a beacon period of the first piconet 110 by using a first time-frequency code TFC1. The first wireless device 111 may determine the occupied medium access slots that are reserved by the second wireless device 113 and/or the third wireless device 115 based on a DRPIE included in the beacon received from the second wireless device 113 and the third wireless device 115.

The first wireless device 111 may receive a beacon from an interference wireless device that is adjacent to the first wireless device 111 and belongs to the interference piconet by overhearing a packet transmitted from the interference piconet by using the time-frequency code of the interference piconet. In an example illustrated in FIG. 1, the first wireless device 111 may use a second-time frequency code TFC2 to receive a beacon from a fourth wireless device 131. The first wireless device 111 may check medium access slots of the second piconet 130 that are reserved by the fourth wireless device 131 based on a DRPIE included in the beacon received from the fourth wireless device 131. Thus, the first wireless device 111 may determine the interference medium access slots of the first piconet 110 that overlap in time with the medium access slots of the second piconet 130 reserved by the fourth wireless device 131. For example, the first wireless device 111 may determine the interference medium access slots by converting numbers of the medium access slots of the second piconet 130 reserved by the fourth wireless device 131 into numbers corresponding to the first piconet 110 based on a time difference between a beacon period start time (BPST) of the first piconet 110 and a BPST of the second piconet 130.

The first wireless device 111 may determine medium access slots of the first piconet 110 as free medium access slots if they are neither the occupied medium access slots nor the interference medium access slots.

The first wireless device 111 may select and reserve medium access slots to be used to transmit a packet based on the classification of the plurality of medium access slots of the first piconet 110. If the number of the medium access slots to be used to transmit the packet is less than or equal to the number of the free medium access slots (S630: YES), the first wireless device 111 may reserve the free medium access slots to transmit the packet (S650). For example, the first wireless device 111 may write information about the free medium access slots to be used to transmit the packet into a DRPIE and may broadcast a beacon including the DRPIE to reserve the free medium access slots to be used.

If the number of the medium access slots to be used to transmit the packet is greater than the number of the free medium access slots (S630: NO), to obtain at least one additional free medium access slot, the first wireless device 111 may request the other wireless device (e.g., the second wireless device 113 and/or the third wireless device 115) reserving the occupied medium access slots to swap at least one of the occupied medium access slots and at least one of the interference medium access slots (S670). For example, in a case where the second wireless device 113 reserves an occupied medium access slot that is not affected by the interference from the second piconet 130, the first wireless device may request the second wireless device 113 to use an interference medium access slot that is not reserved instead of the occupied medium access slot reserved by the second wireless device 113. The second wireless device 113 receiving the request for the swap may be located sufficiently far from the second piconet 130, and thus the second wireless device 113 may not be affected by the interference from the second piconet 130 even if the second wireless device 113 uses the interference medium access slot.

In some exemplary embodiments, to request the other wireless device to swap the occupied medium access slot and the interference medium access slot, the first wireless device 111 may generate a medium access slot swap information element (MAS swap IE) including information about the occupied medium access slot and the interference medium access slot to be swapped and may transmit the MAS swap IE to the other wireless device reserving the occupied medium access slot.

The MAS swap IE may include an address field, a first medium access slot information field and a second medium access slot information field. Each of the first medium access slot information field and the second medium access slot information field may be a medium access slot bitmap of 256 bits. Each bit of the medium access slot bitmap may represent whether a corresponding one of the plurality of medium access slots is designated. To generate the MAS swap IE, the first wireless device 111 may write an address of the other wireless device reserving the occupied medium access slot into the address field, may write information about the occupied medium access slot that is currently used by the other wireless device into the first medium access slot information field, and may write information about the interference medium access slot that is requested to be used by the other wireless device into the second medium access slot information field. For example, in a case where the first wireless device 111 requests the swap to the second wireless device 113, the first wireless device 111 may write an address of the second wireless device 113 into the address field, may write information about an occupied medium access slot reserved by the second wireless device 113 into the first medium access slot information field, and may write information about an interference medium access slot to be swapped for the occupied medium access slot to generate the MAS swap IE.

In some exemplary embodiments, the first wireless device 111 may broadcast a beacon including the MAS swap IE. However, in some exemplary embodiments, the first wireless device 111 may transmit a command frame including the MAS swap IE to the other wireless device.

If the other wireless device receiving the MAS swap IE permits the swap of the occupied medium access slot and the interference medium access slot, the other wireless device may reserve and use the interference medium access slot, and the occupied medium access slot may become a free medium access slot that is not reserved and is not affected by the interference from the second piconet 130. Accordingly, the first wireless device 111 may reserve the free medium access slot that was previously the occupied medium access slot, and may use the reserved free medium access slot to transmit the packet without interference from the second piconet 130 (S690).

If the other wireless device receiving the MAS swap IE rejects the swap of the occupied medium access slot and the interference medium access slot, in some exemplary embodiments, the first wireless device 111 may request the other wireless device to swap another occupied medium access slot reserved by the other wireless device and the interference medium access slot. According to exemplary embodiments, the first wireless device 111 may request still another wireless device to swap an occupied medium access slot reserved by the still another wireless device and the interference medium access slot. According to exemplary embodiments, the first wireless device 111 may reserve and use the free medium access slots, of which the number is less than the desired number. In this case, the plurality of the medium access slots of the first piconet 110 may be properly distributed to the wireless devices 111, 113, and 115 in the first piconet 110 according to a scheduling rule, such as proportional fair scheduling or the like. According to exemplary embodiments, the first wireless devices may reserve and use not only the free medium access slots but also at least one interference medium access slot having the least interference among the interference medium access slots.

As described above, if the first wireless device 111 in the first piconet 110 using the first time-frequency code TFC1 senses the interference from the second piconet 130 using the second time-frequency code TFC2, the first wireless device 111 may classify the medium access slots of the first piconet 110 to reserve medium access slots that are not affected by the interference from the second piconet 130. The first wireless device 111 may reserve the medium access slots that are classified as the free medium access slots. Further, if the number of the free medium access slots is not sufficient, the first wireless device 111 may swap at least one occupied medium access slot and at least one interference medium access slot, and then may reserve the at least one occupied medium access slot that becomes a free medium access slot by the swap. Accordingly, the first wireless device 111 may transmit and/or receive a packet without the interference from and/or to the second piconet 130. According to exemplary embodiments, this method of reserving a medium access slot to avoid the interference may be performed by the first wireless device 111 adjacent to the second piconet 130, may be performed by the fourth wireless device 131 adjacent to the first piconet 110, or may be performed by both of the first wireless device 111 and the fourth wireless device 131. In some exemplary embodiments, prior to performing the method of reserving the medium access slot to avoid the interference, an interference avoidance method illustrated in FIG. 3 may be performed to protect a beacon period of an interference piconet.

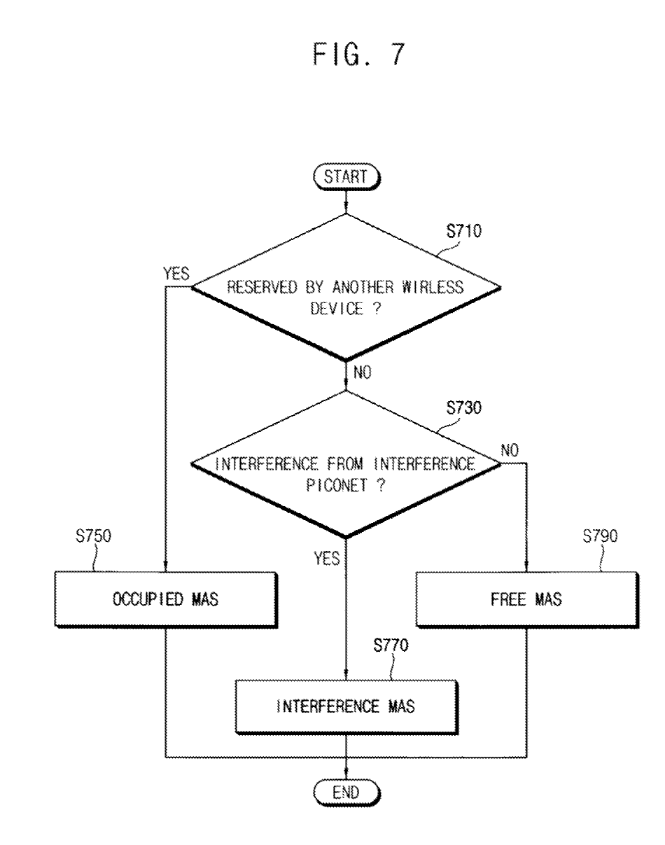

FIG. 7 is a flow chart illustrating an example of a step of classifying a medium access slot in an interference avoidance method of FIG. 6.

Referring to FIGS. 1 and 7, a first wireless device 111 may classify a medium access slot of a first piconet 110 into an occupied medium access slot reserved by another wireless device in the first piconet 110, an interference medium access slot where an interference from a second piconet 130 exists, and a free medium access slot that is not reserved by the other wireless device and is not affected by the interference from the second piconet 130.

If a medium access slot is reserved by the other wireless device in the first piconet 110 (S710: YES), the first wireless device 111 may regard the medium access slot as the occupied medium access slot (S750). For example, the first wireless device 111 may check whether the medium access slot is reserved by the other wireless device by receiving a beacon from the other wireless device.

If a medium access slot is not reserved by the other wireless device (S710: NO), and if the interference from the second piconet 130 exists during the medium access slot (S730: YES), the first wireless device 111 may regard the medium access slot as the interference medium access slot (S770). For example, the first wireless device 111 may check a reserved medium access slot of the second piconet 130 by receiving a beacon of the second piconet 130 by using a second time-frequency code TFC2, and then may determine the interference medium access slot of the first piconet 110 that overlaps in time with the reserved medium access slot of the second piconet 130 by converting a number of the reserved medium access slot of the second piconet 130 into a number corresponding to the first piconet 110. Alternatively, the first wireless device 111 may determine the interference medium access slot of the first piconet 110 by analyzing a preamble and/or a symbol of a packet received from the second piconet 130 during at least one superframe of the second piconet 130.

If a medium access slot is not reserved by the other wireless device (S710: NO), and if the interference from the second piconet 130 does exist during the medium access slot (S730: NO), the first wireless device 111 may regard the medium access slot as the free medium access slot (S790).

As described above, the first wireless device 111 may regard the medium access slot reserved by the other wireless device in the first piconet 110 as the occupied medium access slot (S750), may regard the medium access slot that is not reserved by the other wireless device and is affected by the interference from the second piconet 130 as the interference medium access slot (S770), and may regard the medium access slot that is not reserved by the other wireless device and is not affected by the interference from the second piconet 130 as the free medium access slot (S790).

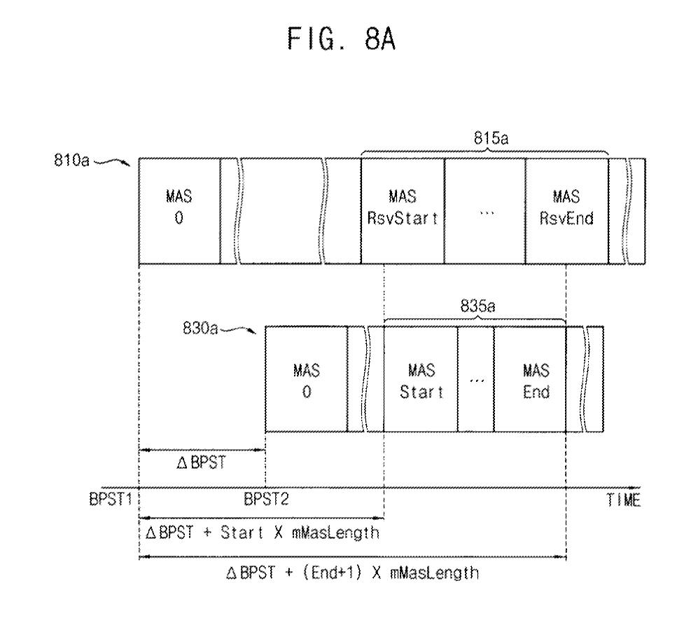

FIGS. 8A and 8B are diagrams illustrating examples of converting numbers of medium access slots of a second piconet into numbers of medium access slots of a first piconet in an interference avoidance method of FIG. 6.

Referring to FIGS. 1 and 8A, if a first wireless device 111 in a first piconet 110 using a first time-frequency code TFC1 senses an interference from a second piconet 130 using a second time-frequency code TFC2, the first wireless device 111 may receive a beacon from an interference wireless device (e.g., a fourth wireless device 131) in the second piconet 130 by using the second time-frequency code TFC2. The first wireless device 111 may check medium access slots 835a that are reserved by the fourth wireless device 131 among medium access slots within a superframe 830a of the second piconet 130 based on a DRPIE included in the beacon received from the fourth wireless device 131. The first wireless device 111 may convert numbers of the medium access slots 835a reserved by the fourth wireless device 131 into numbers corresponding to first piconet 110 to determine medium access slots 815a of the first piconet 110 that overlap in time with the medium access slots 835a of the second piconet 130 reserved by the fourth wireless device 131.

For example, the first wireless device 111 may convert a stat number Start of the medium access slots 835a of the second piconet 130 into a start number RsvStart of the medium access slots 815a of the first piconet 110 by using following equation 1. Further, the first wireless device 111 may convert an end number End of the medium access slots 835a of the second piconet 130 into an end number RsvEnd of the medium access slots 815a of the first piconet 110 by using following equation 2.

$$\begin{matrix}RsvStart = ⌊ \frac{Δ BPST + Start \times mMasLength}{mMasLength} ⌋ & [ equation1 ] \\ RsvEnd = ⌊ \frac{Δ BPST + ( End + 1 ) \times mMasLength}{mMasLength} ⌋ & [ equation2 ]\end{matrix}$$

Here, ΔBPST represents a time difference between a beacon period start time BPST1 of the first piconet 110 and a beacon period start time BPST2 of the second piconet 130. Start represents a number of the first medium access slot reserved by the fourth wireless device 131 in the superframe 830a of the second piconet 130. End represents a number of the last medium access slot reserved by the fourth wireless device 131 in the superframe 830a of the second piconet 130. mMasLength represents a time length of each medium access slot. RsvStart represents a number of the first interference medium access slot in a superframe 810a of the first piconet 110. RsvEnd represents a number of the last interference medium access slot in the superframe 810a of the first piconet 110.

Referring to FIGS. 1 and 8B, in a case where medium access slots 815b of the first piconet 110 that overlap in time with medium access slots 835b of the second piconet 130 reserved by the fourth wireless device 131 are located in the next superframe, the first wireless device 111 may convert a start number Start of the medium access slots 835b of the second piconet 130 into a start number RsvStart of the medium access slots 815b of the first piconet 110 by using following equation 3, and may convert an end number End of the medium access slots 835b of the second piconet 130 into an end number RsvEnd of the medium access slots 815b of the first piconet 110 by using following equation 4.

$$\begin{matrix}RsvStart = ⌊ \frac{Δ BPST + Start \times mMasLength - mSuperframeLength}{mMasLength} ⌋ & [ equation3 ] \\ RsvEnd = ⌊ \frac{\begin{matrix}Δ BPST + ( End + 1 ) \times mMasLength - \\ mSuperframeLength\end{matrix}}{mMasLength} ⌋ & [ equation4 ]\end{matrix}$$

Here, ΔBPST represents a time difference between a beacon period start time BPST1 of the first piconet 110 and a beacon period start time BPST2 of the second piconet 130. Start represents a number of the first medium access slot reserved by the fourth wireless device 131 in the superframe 830b of the second piconet 130. End represents a number of the last medium access slot reserved by the fourth wireless device 131 in the superframe 830b of the second piconet 130. mMasLength represents a time length of each medium access slot. mSuperframeLength represents a time length of each superframe. RsvStart represents a number of the first interference medium access slot in a superframe 810b of the first piconet 110. RsvEnd represents a number of the last interference medium access slot in the superframe 810b of the first piconet 110.

As illustrated in FIGS. 8A and 8B, the first wireless device 111 may determine interference medium access slots of the first piconet 110 by converting numbers of the reserved medium access slots 835a and 835b of the second piconet 130 into numbers of the medium access slots 815a and 815b of the first piconet 110.

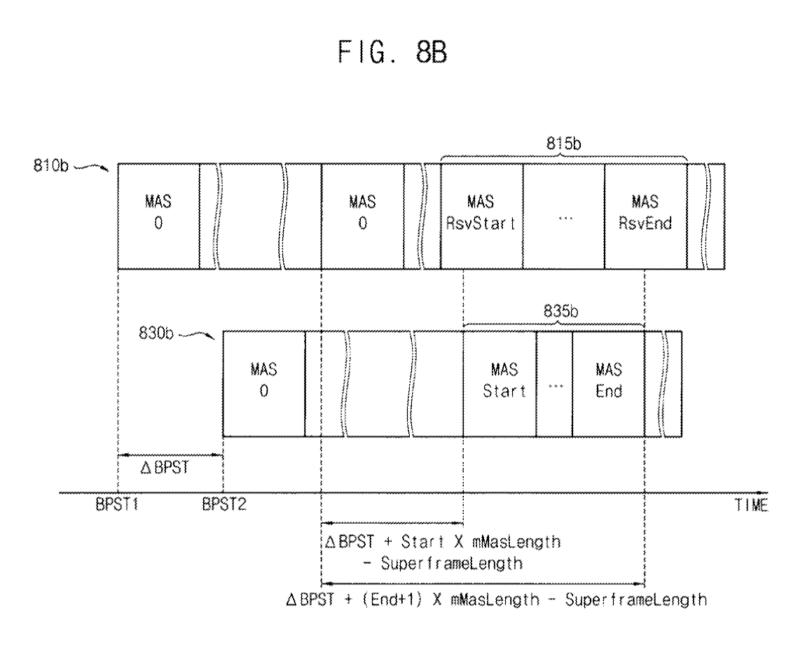

FIG. 9 is a diagram illustrating an example of swapping occupied medium access slots and interference medium access slots in an interference avoidance method of FIG. 6.

FIG. 9 illustrates a superframe 910 before a swap of medium access slots and a superframe 930 after the swap of the medium access slots. Although superframes 910 and 930 each of which includes 8 medium access slots are illustrated in FIG. 9 for the sake of convenience, one superframe may typically include 256 medium access slots.

Referring to FIGS. 1 and 9, a first wireless device 111 in a first piconet 110 may determine occupied medium access slots 911, 912, 913, and 914 within the superframe 910 by receiving a beacon from a second wireless device 113 and a third wireless device 115 during a beacon period of the first piconet 110 by using a first time-frequency code TFC1. The first wireless device 111 may check medium access slots of a second piconet 130 reserved by an interference wireless device (e.g., a fourth wireless device 131) by receiving a beacon from the interference wireless device during a beacon period of the second piconet 130 by using a second time-frequency code TFC2. Further, the first wireless device 111 may determine interference medium access slots 917 and 918 within the superframe 910 by converting numbers of the medium access slots of the second piconet 130 reserved by the interference wireless device into numbers in the superframe 910 of the first piconet 110. The first wireless device 111 may regard medium access slots that are neither the occupied medium access slots 911, 912, 913, and 914 nor the interference medium access slots 917 and 918 as free medium access slots 915 and 916.

If the number of the free medium access slots 915 and 916 is not sufficient to transmit a packet, the first wireless device 111 may request another wireless device (e.g., the second wireless device 113 and/or the third wireless device 115) in the first piconet 110 reserving the occupied medium access slots 911, 912, 913, and 914 to swap of at least one of the occupied medium access slots 911, 912, 913, and 914 and at least one of the interference medium access slots 917 and 918.

For example, in a case where the first wireless device 111 requires four medium access slots to transmit the packet, two free medium access slots 915 and 916 exist in the superframe 910, and four occupied medium access slots 911, 912, 913, and 914 are reserved by the second wireless device 113, the first wireless device 111 may request the second wireless device 113 to swap two of the four occupied medium access slots 911, 912, 913, and 914 and two interference medium access slots 917 and 918.

If the two occupied medium access slots 913 and 914 and the two interference medium access slots 917 and 918 are swapped, the second wireless device 113 may use other two occupied medium access slots 931 and 932 that are not requested to be swapped and medium access slots 937 and 938 that were previously the interference medium access slots 917 and 918. The second wireless device 113 may be located sufficiently far from the second piconet 130, and thus the second wireless device 113 may not be affected by the interference from the second piconet 130 even if the second wireless device 113 uses the medium access slots 937 and 938.

The swapped two occupied medium access slots 913 and 914 may become free medium access slots 933 and 934 by the swap, and the first wireless device 111 may transmit the packet using four free medium access slots 933, 934, 935, and 936. Accordingly, the first wireless device 111 may transmit the packet without the interference from and/or to the second piconet 130.

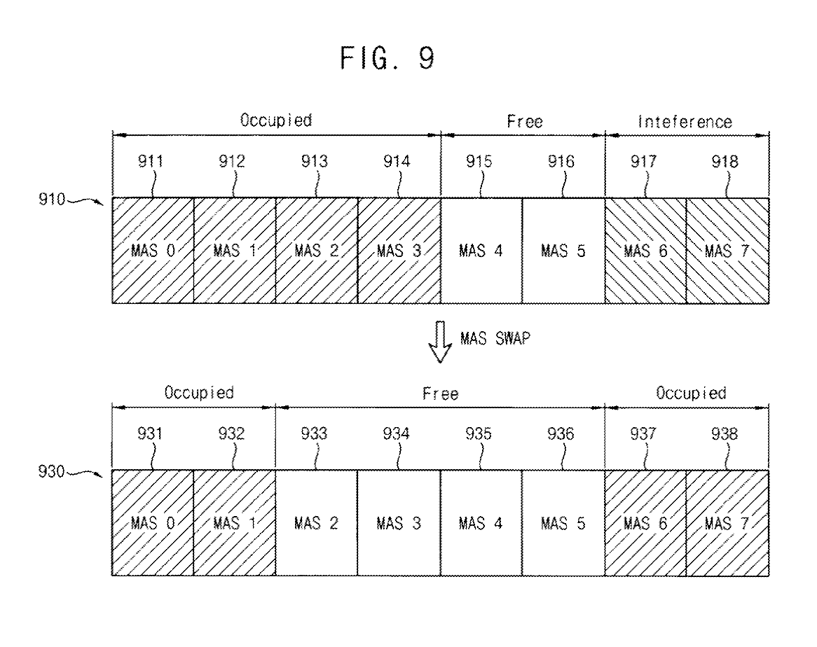

FIG. 10 is a diagram illustrating an example of a MAS swap IE used in an interference avoidance method of FIG. 6.

Referring to FIGS. 1 and 10, a first wireless device 111 may use a MAS swap IE 1000 to request a swap of at least one occupied medium access slot and at least one interference medium access slot. In an example illustrated in FIG. 9, if the number of free medium access slots 915 and 916 is not sufficient, the first wireless device 111 may request a swap of occupied medium access slots 913 and 914 and interference medium access slots 917 and 918 by using the MAS swap IE 1000.

The MAS swap IE 1000 may include an element identification (ID) field 1010, a length field 1020, an address field 1030, a first medium access slot information field 1040, and a second medium access slot information field 1050. A predetermined value indicating the MAS swap IE 1000 may be written into the element ID field 1010. For example, the predetermined value indicating the MAS swap IE 1000 may be 3. A sum of a length of the address field 1030, a length of the first medium access slot information field 1040 and a length of the second medium access slot information field 1050 may be written into the length field 1020. For example, in a case where the address field 1030 has a length of 1 byte, each of the first medium access slot information field 1040 and the second medium access slot information field 1050 has a length of 32 bytes, 65 may be written into the length field 1020.

An address of a wireless device to receive the MAS swap IE 1000 may be written into the address field 1030. For example, to transmit the MAS swap IE 1000 to a second wireless device 113, the first wireless device 111 may write an address of the second wireless device 113 into the address field 1030.

Information about the at least one occupied medium access slot may be written into the first medium access slot information field 1040. In an example illustrated in FIG. 9, the first wireless device 111 may write information about two occupied medium access slots 913 and 914 reserved by the second wireless device 113 into the first medium access slot information field 1040. In some exemplary embodiments, the first medium access slot information field 1040 may include a medium access slot bitmap 1045 of 256 bits. Each bit of the medium access slot bitmap 1045 may represent whether a corresponding one of the medium access slots is designated. For example, when a medium access slot is requested to be swapped, a corresponding bit of the medium access slot bitmap 1045 may have a value of 1.

Information about the at least one interference medium access slot may be written into the second medium access slot information field 1050. According to an exemplary embedment illustrated in FIG. 9, the first wireless device 111 may write information about two interference medium access slots 917 and 918 that are to be used by the second wireless device 113 into the second medium access slot information field 1050. In some exemplary embodiments, the second medium access slot information field 1050 may include a medium access slot bitmap of 256 bits. Each bit of the medium access slot bitmap may represent whether a corresponding one of the medium access slots is designated.

To request a swap to the second wireless device 113, the first wireless device 111 may broadcast a beacon including the MAS swap IE 1000 or may transmit a command frame including the MAS swap IE 1000 to the second wireless device 113.

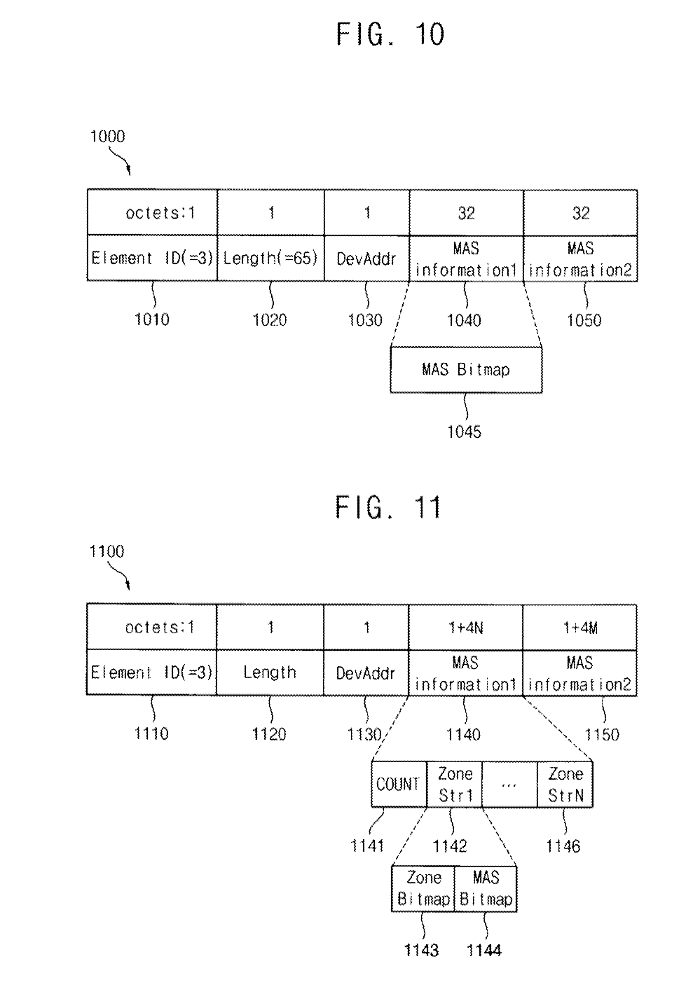

Referring to FIGS. 1 and 11, a MAS swap IE 1100 may include an element ID field 1110, a length field 1120, an address field 1130, a first medium access slot information field 1140 and a second medium access slot information field 1150. A predetermined value indicating the MAS swap IE 1100 may be written into the element ID field 1110. A sum of a length of the address field 1130, a length of the first medium access slot information field 1140, and a length of the second medium access slot information field 1150 may be written into the length field 1120. For example, the first medium access slot information field 1140 may have a variable length “1+4N”. The second medium access slot information field 1150 may have a variable length “1+4M”. “3+4N+4M” may be written into the length field 1120. Here, N is an integer greater than 0 and M is an integer greater than 0. An address of a wireless device to receive the MAS swap IE 1100 may be written into the address field 1130.

Information about at least one occupied medium access slot may be written into the first medium access slot information field 1140. The first medium access slot information field 1140 may include a zone structure count field 1141 and N zone structure fields 1142 and 1146. Each zone structure field 1142 and 1146 may include a zone bitmap 1143 and a medium access slot bitmap 1144. For example, one superframe may include 256 medium access slots and the 256 medium access slots may be grouped into 16 zones, of which each includes 16 medium access slots. In this case, the zone bitmap 1143 may have a length of 2 bytes or 16 bits and the medium access slot bitmap 1144 may have a length of 2 bytes or 16 bits. Each bit of the zone bitmap 1143 may represent whether a corresponding zone is designated and each bit of the medium access slot bitmap 1144 may represent whether a corresponding medium access slot in the designated zone is designated. Further, the first medium access slot information field 1140 may include 1 to 16 zone structures.

Information about at least one interference medium access slot may be written into the second medium access slot information field 1150. The second medium access slot information field 1150 may include a zone structure count field and M zone structure fields. For example, in a case where one superframe may include 256 medium access slots and the 256 medium access slots may be grouped into 16 zones, the second medium access slot information field 1150 may include 1 to 16 zone structures.

To request a swap to the second wireless device 113, the first wireless device 111 may broadcast a beacon including the MAS swap IE 1100 or may transmit a command frame including the MAS swap IE 1100 to the second wireless device 113.

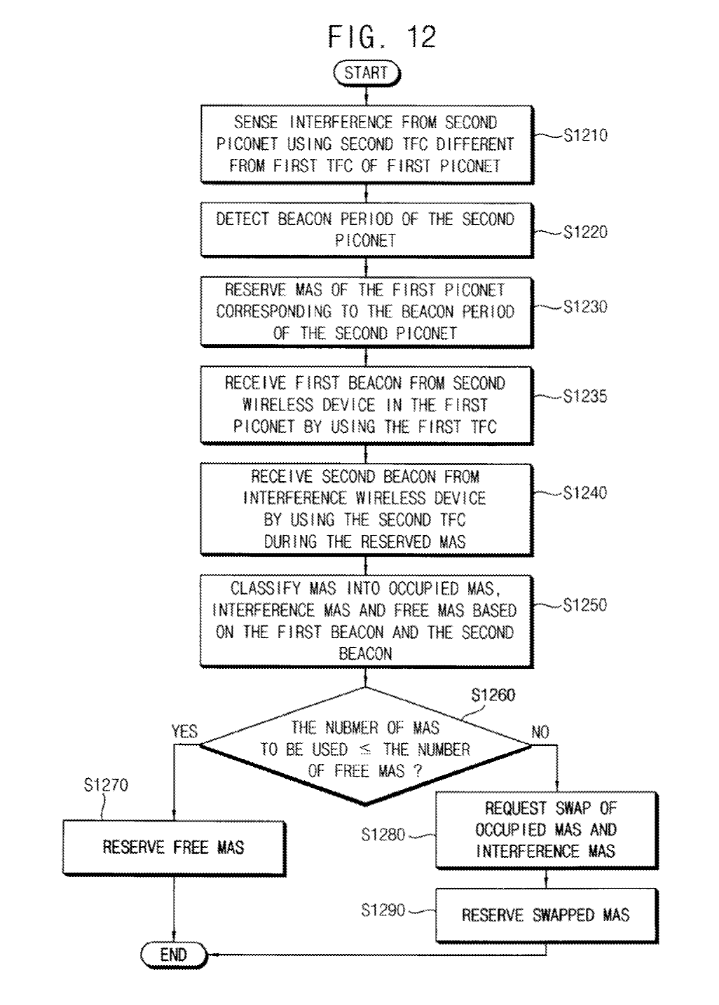

FIG. 12 is a flow chart illustrating a method of avoiding interference in a multi-piconet according to exemplary embodiments of the present invention.

Referring to FIGS. 1 and 12, a first wireless device 111 in a first piconet 110 using a first time-frequency code TFC1 may sense interference from a second piconet 130 using a second time-frequency code TFC2 that is different from the first time-frequency code TFC1 (S1210). For example, the first wireless device 111 may sense the interference from the second piconet 130 by analyzing a preamble and/or a symbol of a received packet.

If the interference from the second piconet 130 is sensed, the first wireless device 111 may detect a beacon period of the second piconet 130 (S1220). For example, the first wireless device 111 may detect a beacon period start time and a beacon period length of the second piconet 130 by receiving a beacon of the second piconet 130. To receive the beacon of the second piconet 130, the first wireless device may overhear a packet transmitted from the second piconet 130 by using the second time-frequency code TFC2 during a period in which the interference from the second piconet 130 is sensed.

The first wireless device 111 may reserve at least one medium access slot of the first piconet 110 corresponding to the beacon period of the second piconet 130 (S1230). For example, the first wireless device 111 may reserve the at least one medium access slot that overlaps in time with the beacon period of the second piconet 130 as an interference piconet beacon period protection type. Accordingly, wireless devices 111, 113, and 115 in the first piconet 110 may refrain from transmitting a packet during the beacon period of the second piconet 130, and thus wireless devices 131, 133, and 135 in the second piconet 130 may transmit and receive a beacon without interference from the First piconet 110.

The first wireless device 111 may receive a first beacon from second and third wireless devices 113 and 115 in the first piconet 110 during a beacon period of the first piconet 110 (S1235). Further, the first wireless device 111 may receive a second beacon from a fourth wireless device 131 in the second piconet 130 by using the second time-frequency code TFC2 during the beacon period of the second piconet 130 or during the reserved at least one medium access slot of the first piconet 110 (S1240). The first wireless device 111 may classify medium access slots of the first piconet 110 into occupied medium access slots, interference medium access slots, and free medium access slots based on the first beacon and the second beacon (S1250). For example, the first wireless device 111 may determine the occupied medium access slots based on the first beacon, may determine the interference medium access slots based on the second beacon, and may regard remaining medium access slots as the free medium access slots.

If the number of medium access slots to be used to transmit a packet is less than or equal to the number of the free medium access slots (S1260: YES), then the first wireless device 111 may reserve the free medium access slots to transmit the packet (S1270).

If, however, the number of the medium access slots to be used to transmit the packet is greater than the number of the free medium access slots (S1260: NO), the first wireless device 111 may request another wireless device reserving the occupied medium access slots to swap at least one occupied medium access slot and at least one interference medium access slot (S1280). If the at least one occupied medium access slot and the at least one interference medium access slot are swapped, the at least one occupied medium access slot may become an additional free medium access slot where the interference from the second piconet 130 does not exists and the first wireless device may reserve the additional free medium access slot (S1290). Accordingly, the first wireless device 111 may transmit the packet without the interference from and/or to the second piconet 130.

As described above, a method of avoiding interference in a multi-piconet according to exemplary embodiments may reserve at least one medium access slot corresponding to a beacon period of an interference piconet using a time-frequency code different from a time-frequency code of a current piconet. Accordingly, the method of avoiding the interference in the multi-piconet according to exemplary embodiments may allow beacons to be transmitted and/or received without the interference during a beacon period. Further, the method of avoiding the interference in the multi-piconet according to exemplary embodiments may swap an occupied medium access slot and an interference medium access slot to transmit and/or receive a packet without the interference during a data period.

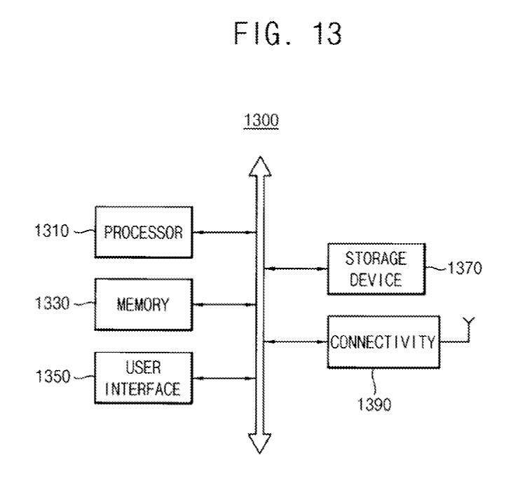

FIG. 13 is a block diagram illustrating a wireless device according to exemplary embodiments of the present invention.

Referring to FIG. 13, a wireless device 1300 includes a processor 1310, a memory device 1330, a user interface 1350, a storage device 1370 and a connectivity unit 1390.

The processor 1310 may perform specific calculations or tasks. For example, the processor 1310 may be a microprocessor, a central process unit (CPU), a digital signal processor, or the like. The processor 1310 may be coupled to the memory device 1330 via a bus, such as an address bus, a control bus and/or a data bus. For example, the memory device 1330 may be implemented by a volatile memory device, such as a dynamic random access memory (DRAM), a static random access memory (SRAM), a mobile DRAM, etc. Alternatively, the memory device 1330 may be implemented by a nonvolatile memory device, such as an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), etc. The processor 130 may be coupled to the user interface 1350 via an extension bus, such as a peripheral component interconnect (PCI) bus. The user interface 1350 may include at least one input device, such as a keypad, a touch screen, etc., and at least one output device, such as a display device, a speaker, etc. The processor 130 may be further coupled to the storage device 1370, such as a memory card, a solid state drive (SSD), a hard disk drive (HDD), a CD-ROM, etc.

The connectivity unit 1390 may perform wired and/or wireless communication with an external device. For example, the connectivity unit 1390 may perform multi-band orthogonal frequency division multiplexing (MB-OFDM) ultra-wideband (UWB) communication. In some exemplary embodiments, the connectivity unit 1390 may further perform USB communication, Ethernet communication, near field communication (NFC), radio frequency identification (RFID) communication, mobile telecommunication, memory card communication, wireless internet, wireless fidelity (Wi-Fi), global positioning system (GPS), Bluetooth (BT), global system for mobile communication (GSM), general packet radio system (GPRS), wideband code division multiple access (WCDMA), high speed uplink/downlink packet access (HSxPA), etc. In some exemplary embodiments, the wireless device 1300 may further include a power supply, an application chipset, a camera image processor (CIS), etc.

According to exemplary embodiments, the wireless device 1300 and/or components of the wireless device 1300 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

The wireless device 1300 according to exemplary embodiments may allow beacons to be transmitted and/or received without interference by reserving at least one medium access slot corresponding to a beacon period of an interference piconet. Further, the wireless device 1300 according to exemplary embodiments may transmit and/or receive a packet by swapping an occupied medium access slot and an interference medium access slot.

According to exemplary embodiments of the present invention, the wireless device 1300 may be any computing system, such as a mobile phone, a smart phone, a personal computer, a tablet computer, a laptop computer, a personal digital assistant (PDA), a portable multimedia player (PMP), a digital camera, a portable game console, a music player, a camcorder, a video player, a navigation system, etc.

Exemplary embodiments may be applied to any form of wireless communication. For example, exemplary embodiments may be applied to MB-OFDM UWB communication.

The foregoing is illustrative of exemplary embodiments and is not to be construed as limiting thereof. Although exemplary embodiments have been described, those skilled in the art will readily appreciate that many modifications are possible without materially departing from the present inventive concept.

What is claimed is:

1. A method of avoiding interference in a multi-piconet, the method comprising:
sensing, by a wireless device in a first piconet using a first time-frequency code, interference from a second piconet using a second time-frequency code that is different from the first time-frequency code;
detecting, by the wireless device in the first piconet, a beacon period of the second piconet; and
reserving, by the wireless device in the first piconet, at least one medium access slot, among a plurality of medium access slots of the first piconet, corresponding to the beacon period of the second piconet.

2. The method of claim 1, wherein sensing the interference from the second piconet comprises:
receiving a packet at the wireless device in the first piconet; and
determining whether a preamble included in the received packet corresponds to the first time-frequency code.

3. The method of claim 1, wherein sensing the interference from the second piconet comprises:
receiving a packet at the wireless device in the first piconet; and
determining whether the interference from the second piconet exists based on a receiver signal strength indicator (RSSI) and a link quality indicator (LQI) of a symbol included in the received packet.

4. The method of claim 1, wherein detecting the beacon period of the second piconet comprises:
receiving, at the wireless device in the first piconet, a beacon of the second piconet by overhearing a packet transmitted from the second piconet using the second time-frequency code; and
detecting the beacon period of the second piconet based on a beacon period occupancy information element included in the received beacon of the second piconet.

5. The method of claim 1, wherein reserving the at least one medium access slot corresponding to the beacon period of the second piconet comprises:
reserving at least one medium access slot that overlaps in time with the beacon period of the second piconet and characterizing the reserved at least one medium access slot as an interference piconet beacon period protection type.

6. The method of claim 1, wherein reserving the at least one medium access slot corresponding to the beacon period of the second piconet comprises:
writing a predetermined value indicating an interference piconet beacon period protection type into a reservation type field of a distributed reservation protocol information element; and
broadcasting, by the wireless device in the first piconet, a beacon including the distributed reservation protocol information element in the first piconet.

7. The method of claim 6, wherein the predetermined value indicating the interference piconet beacon period protection type is one of 5, 6, or 7.

8. The method of claim 1, wherein when the at least one medium access slot is reserved, all wireless devices in the first piconet do not transmit a packet during the reserved one medium access slot.

9. A method of avoiding interference in a multi-piconet including a first piconet using a first time-frequency code and a second piconet using a second time-frequency code that is different from the first time-frequency code, the method comprising:
classifying, by a first wireless device in the first piconet, each of a plurality of medium access slots of the first piconet as one of:
occupied medium access slots that are reserved by at least one second wireless device in the first piconet;
interference medium access slots where an interference from the second piconet exists; and
free medium access slots that are not reserved and are not affected by the interference from the second piconet,
wherein when a number of medium access slots to be used to transmit a packet by the first wireless device in the first piconet is less than or equal to a number of the free medium access slots, the first wireless device in the first piconet reserves at least one of the free medium access slots to transmit the packet, and
when the number of the medium access slots to be used to transmit the packet by the first wireless device in the first piconet is greater than the number of the free medium access slots, the first wireless device in the first piconet requests the second wireless device in the first piconet to swap at least one of the occupied medium access slots and at least one of the interference medium access slots.

10. The method of claim 9, wherein classifying the plurality of medium access slots into the occupied medium access slots, the interference medium access slots and the free medium access slots comprises:
receiving a beacon from the second wireless device in the first piconet during a beacon period of the first piconet by using the first time-frequency code; and
determining the occupied medium access slots based on a distributed reservation protocol information element included in the received beacon.

11. The method of claim 9, wherein classifying the plurality of medium access slots into the occupied medium access slots, the interference medium access slots and the free medium access slots comprises:
receiving a beacon from an interference wireless device in the second piconet during a beacon period of the second piconet by using the second time-frequency code;
checking medium access slots of the second piconet reserved by the interference wireless device in the second piconet based on a distributed reservation protocol information element included in the received beacon; and
determining the interference medium access slots of the first piconet that overlap in time with the medium access slots of the second piconet reserved by the interference wireless device in the second piconet.

12. The method of claim 11, wherein determining the interference medium access slots of the first piconet comprises:
converting numbers of the medium access slots of the second piconet reserved by the interference wireless device in the first piconet into numbers corresponding to the first piconet based on a time difference between a beacon period start time of the first piconet and a beacon period start time of the second piconet.

13. The method of claim 9, wherein classifying the plurality of medium access slots into the occupied medium access slots, the interference medium access slots and the free medium access slots comprises:
determining medium access slots among the plurality of medium access slots of the first piconet that are neither the occupied medium access slots nor the interference medium access slots as the free medium access slots.

14. The method of claim 9, wherein requesting the second wireless device in the first piconet to swap at least one of the occupied medium access slots and at least one of the interference medium access slots comprises:
generating, by the first wireless device, a medium access slot swap information element including information about the at least one of the occupied medium access slots reserved by the second wireless device in the first piconet and information about the at least one of the interference medium access slots where the interference from the second piconet exists; and
transmitting, by the first wireless device in the first piconet, the medium access slot swap information element to the second wireless device in the first piconet.

15. The method of claim 14, wherein generating the medium access slot swap information element comprises:
writing an address of the second wireless device in the first piconet into an address field of the medium access slot swap information element;
writing the information about the at least one of the occupied medium access slots into a first medium access slot information field of the medium access slot swap information element; and
writing the information about the at least one of the interference medium access slots into a second medium access slot information field of the medium access slot swap information element.

16. A method for controlling a piconet, comprising:
detecting, by a first wireless device in a first piconet that uses a first time-frequency code, a second piconet using a second time-frequency code that is different from the first time-frequency code;
identifying, by the first wireless device in the first piconet, a beacon period of the second piconet; and
refraining from transmitting packets, in the first piconet, during a medium access slot (MAS) that overlaps in time with the identified beacon period of the second piconet.

17. The method of claim 16, wherein the first piconet refrains from transmitting packets during the MAS that overlaps in time with the identified beacon period of the second piconet by reserving the MAS that overlaps in time with the identified beacon period of the second piconet as a reserved MAS.

18. The method of claim 16, wherein detecting the second piconet comprises:
receiving a packet at the first wireless device of the first piconet;
determining whether a preamble of the received packet corresponds to the first time-frequency code; and
detecting the second piconet when the preamble of the received packet is determined to not correspond to the first time-frequency code.

19. The method of claim 16, further comprising:
determining, by the first wireless device in the first piconet, whether there is a sufficient number of MASs that do no overlap in time with the identified beacon period of the second piconet; and
when it is determined that there is not a sufficient number of MASs that do no overlap in time with the identified beacon period of the second piconet, the first wireless device in the first piconet sends a request to a second wireless device in the first piconet to swap a MAS that is used for transmitting packets for a MAS that overlaps in time with the identified beacon period of the second piconet.

20. The method of claim 16, wherein the first wireless device in the first piconet transmits packets during one or more MASs that do not overlap in time with the identified beacon period of the second piconet.
